(19) United States
(12) Patent Application Publication
(10) Pub. No.: US 2026/0160945 A1
(43) Pub. Date: Jun. 11, 2026

(54) METHOD OF FABRICATING A PHOTONIC INTEGRATED CIRCUIT

(71) Applicant: The Regents of The University of Michigan, Ann Arbor, MI (US)

(72) Inventors: Shuai LIU, Ann Arbor, MI (US); Zheshen ZHANG, Ann Arbor, MI (US)

(73) Assignee: The Regents of The University of Michigan, Ann Arbor, MI (US)

(21) Appl. No.: 19/411,854

(22) Filed: Dec. 8, 2025

Related U.S. Application Data
(60) Provisional application No. 63/729,567, filed on Dec. 9, 2024.

(51) Int. Cl. G02B 6/132; G02B 6/12; G02B 6/136

(52) U.S. Cl. CPC G02B 6/132; G02B 6/136; G02B 2006/12169; G02B 2006/12173

(57) ABSTRACT

A method of fabricating a photonic integrated circuit is presented. The method includes forming one or more trenches through a first layer of silicon nitride and a first layer of silicon dioxide on a substrate. The first layer of silicon dioxide is disposed on the substrate and the first layer of silicon nitride is disposed on the first layer of silicon dioxide. The method includes depositing a second layer of silicon nitride on the first layer of silicon nitride, then depositing another layer of silicon on the second layer of silicon nitride. The another layer of silicon has an amorphous structure. The method includes patterning at least one of the another layer of silicon, the first and second layers of silicon nitride, and the first layer of silicon dioxide to form an integrated circuit. The method further includes removing the another layer of silicon.

### CROSS-REFERENCE TO RELATED APPLICATIONS

This application claims the benefit of U.S. Provisional Application No. 63/729,567, filed on Dec. 9, 2024. The entire disclosure of the above application is incorporated herein by reference.

### GOVERNMENT CLAUSE

This invention was made with government support under 2330310, 2326780, and 2317471 awarded by the National Science Foundation. The government has certain rights in the invention.

### FIELD

The present disclosure relates to method of fabricating photonic integrated circuits.

### BACKGROUND

In general, silicon photonics offers compact, scalable, and energy-efficient platform for integrated optical technologies. Silicon nitride (Si₃N₄) photonic integrated circuits (PICs) offer a unique combination of low optical loss, a large transparency window spanning from visible to mid-infrared, high power handling, high refractive index, moderate nonlinearity, and absence of free carrier absorption, enabling rapid advances across various fields, including quantum photonics, narrow-linewidth lasers, frequency comb generation, optical communication, among many others. In nonlinear optics, Si₃N₄ PICs are particularly attractive due to their ultra-low optical losses in tandem with appreciable Kerr nonlinearity, underpinning applications such as supercontinuum generation, parametric amplification, and dissipative Kerr solitons (DKS). These applications rely heavily on tight optical confinement and precise dispersion engineering, which necessitates the use of thick Si₃N₄ layers (e.g., a Si₃N₄ layer having a thickness that is greater than 600 nanometers (nm)) to enter the desired anomalous dispersion regime.

However, growing thick Si₃N₄ films and fabricating high-quality PICs presents many challenges. For example, low-pressure chemical vapor deposition (LPCVD) is commonly used to grow Si₃N₄ films with high quality and low propagation loss, but it induces substantial tensile stress that leads to cracking at film thicknesses exceeding 400 nm, thereby severely limiting the performance, yield, and scalability of Si₃N₄ PICs.

To date, several approaches have been developed to improve cracking in Si₃N₄ films. For instance, the photonic Damascene process has mitigated cracking and achieved optical losses (˜1 dB/m) in Si₃N₄ waveguides by embedding them within a trench-like silicon dioxide (SiO₂) layer. While this approach offers advantages, it poses challenges in maintaining precise waveguide dimension control, which is essential for applications demanding consistent mode dispersion and wafer-scale uniformity. Moreover, the photonic Damascene process involves multiple high-temperature, time-consuming steps and is hindered by issues such as the dishing effect, which cast concerns over its cost effectiveness and complexity.

An alternative approach includes subtractive processing, which introduces cracking-isolation trenches to prevent crack propagation within the Si₃N₄ films. Subtractive processing features a more uniform film thickness across the whole wafer by directly depositing the Si₃N₄ film onto patterned wafers, while also lends greater flexibility to fabricating large-scale patterns, such as arrayed waveguide gratings (AWG) or multimode interferometers (MMI), where the Damascene process could suffer from the dishing effect. The subtractive processing based on e-beam lithography exposure and SiO₂ hardmask etching yielded the lowest optical losses to date-Qi=37×10⁶ and a propagation loss of 0.8 dB/m. However, in contrast to the Damascene processes, SiO₂ trenches that undergo high-temperature thermal reflow to smooth sidewalls, the subtractive method requires highly optimized fabrication recipes and complex steps to prevent roughness accumulation and produce smooth Si₃N₄ waveguides.

More recently, deep ultraviolet (DUV) stepper photolithography was exploited in wafer-scale fabrication, achieving Qi values exceeding 28×10⁶. Although other approaches, such as multi-step slow LPCVD Si₃N₄ deposition with special rotation and annealing cycles, sputtering-based Si₃N₄ film deposition, and inductively coupled plasma-chemical vapor deposition (ICP-CVD) growth using hydrogen-free precursors, have been developed to grow crack-free Si₃N₄ PICs, they have not yet yielded high Q factors on par with those obtained with standard LPCVD Si₃N₄. Despite the aforementioned numerous advancements in developing thick Si₃N₄ films, to date a reliable and straightforward fabrication technique that preserves the high quality of Si₃N₄ PICs remains elusive.

It is advantageous to fabricate photonic integrated circuits having thick Si₃N₄ films (e.g., having a thickness of greater than or equal to about 600 nm), having reduced or eliminated crack propagation while achieving the desired Q factor characteristics. Moreover, it is advantageous to fabricate photonic integrated circuits having thick Si₃N₄ films that may be stored with a reduced risk of cracking. It is also advantageous to utilize highly robust, high-yield, and reliable methods for fabricating high-quality Si₃N₄ PICs that are suitable for foundry-scale manufacturing.

In various aspects of the present disclosure, an amorphous silicon (a-Si) etching technique for robust fabrication of ultra-low-loss, dispersion-engineered Si₃N₄ PICs with film thicknesses that are greater than or equal to about 775 nm. This disclosure also provides cracking-isolation trench designs allowing for long-term storage of crack-free Si₃N₄ wafers in a ready-to-use state.

This section provides background information related to the present disclosure which is not necessarily prior art.

### SUMMARY

This section provides a general summary of the disclosure, and is not a comprehensive disclosure of its full scope or all of its features.

In one aspect, a method of fabricating a photonic integrated circuit includes forming one or more trenches through a first layer of silicon nitride and a first layer of silicon dioxide on a substrate. The first layer of silicon dioxide is disposed on the substrate and the first layer of silicon nitride is disposed on the first layer of silicon dioxide. The method further includes depositing a second layer of silicon nitride on the first layer of silicon nitride and subsequently depositing another layer of silicon on the second layer of silicon nitride. The another layer of silicon has an amorphous structure. The method further includes patterning at least one of the another layer of silicon, the first and second layers of silicon nitride, and the first layer of silicon dioxide to form an integrated circuit. The method further includes removing the another layer of silicon.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flow chart of a method of fabricating a photonic integrated circuit;

FIG. 2 is a schematic illustrating an example embodiment of fabricating a photonic integrated circuit;

FIG. 3A shows photographs of exemplary photonic integrated circuits that were fabricated using the method of FIGS. 1 and 2;

FIG. 3B is a dark field microscope image of a conventional photonic integrated circuit and the photonic integrated circuit after removing amorphous silicon layer of FIG. 3A;

FIGS. 4A-4C are Atomic Force Microscopy (AFM) measurements showing the surface roughness of the first layer of silicon nitride (FIG. 4A), the second layer of silicon nitride (FIG. 4B), and the layer of amorphous silicon (FIG. 4C);

FIGS. 5A-5F are scanning electron microscope (SEM) (FIGS. 5A-5D) and false-color SEM (FIGS. 5E-5F) images showing the patterning process (FIGS. 5A-5C) and fabricated Si₃N₄ microring resonator (FIG. 5D-5F);

FIGS. 6A-6H show characterization of the fabricated Si₃N₄ microring resonator of FIGS. 5A-5F, including a measured normalized transmission (Norm. Trans.) spectrum of quasi-TE waveguide modes from 1550 nm to 1630 nm (FIG. 6A), extracted intrinsic quality factors (Qᵢ) of the quasi-TE modes (FIG. 6B), zoom-in view of a resonance with an intrinsic linewidth of κ₀=6.32×10⁻² pm, corresponding to Q=25.6×10⁶ (million, M) (FIG. 6C), a histogram of the extracted Qᵢ factors, showing a most probable value of Qᵢ=21.0 M (FIG. 6D), normalized transmission spectra (FIG. 6E) and extracted Qᵢ factors (FIG. 6F) of quasi-TM waveguide modes, zoom-in view of a resonance with an intrinsic linewidth of κ₀=7.17×10⁻² pm, corresponding to Qᵢ=22.9 M (FIG. 6G), and histogram of the Q factors for the quasi-TM modes, showing a most probable value of Qᵢ=17.8 M (FIG. 6H);

FIG. 7A is a schematic of an experimental set-up for generation and characterization of frequency combs of a photonic integrated circuit;

FIG. 7B is a chart showing frequency combs generated from the experiment of FIG. 7A;

FIGS. 8A-8B are a photograph of an exemplary microring resonator that was fabricated using the method of FIGS. 1 and 2 (FIG. 8A) and a schematic of a thickness map of a layer of Si₃N₄ of the exemplary microring resonator (FIG. 8B);

FIGS. 9A-9E show characterization of the fabricated Si₃N₄ microring resonator of FIGS. 8A-8B, including a cross-section schematic of a Si₃N₄ waveguide (FIG. 9A); electrical field distributions of the TE₀₀ (FIG. 9B) and TM₀₀ (FIG. 9C) modes; and charts showing simulated group velocity dispersion maps as function of waveguide width and length for the TE₀₀ (FIG. 9D) and TM₀₀ (FIG. 9E) modes at a wavelength of 1570 nm;

FIGS. 10A-10D show a photograph of two exemplary photonic integrated circuits that were fabricated using the method of FIGS. 1 and 2 (FIG. 10A); and SEM photographs of a microring resonator of one of the photonic integrated circuits of FIG. 10A fabricated using UV stepper lithography (FIGS. 10B-10C);

FIGS. 11A-11D show characterization of exemplary Si₃N₄ microring resonators of FIG. 10A-10D including charts showing high-Q TE₀₀ resonance (FIGS. 11A and 11D); charts showing statistical distribution of Qi values (FIGS. 11B and 11E); and charts showing extracted Qi values as a function of wavelength (FIGS. 11C and 11F);

FIG. 12A is a schematic of an experimental set-up for generation and characterization of frequency combs of a photonic integrated circuit; and

FIG. 12B-12C are charts showing frequency combs generated from the experiment of FIG. 12A.

Corresponding reference numerals indicate corresponding parts throughout the several views of the drawings.

### DETAILED DESCRIPTION

Example embodiments will now be described more fully with reference to the accompanying drawings.

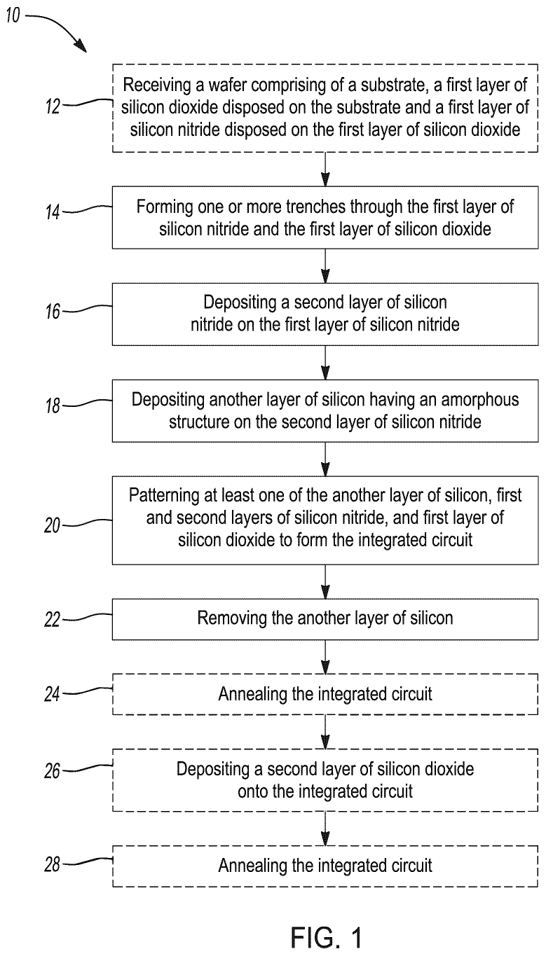

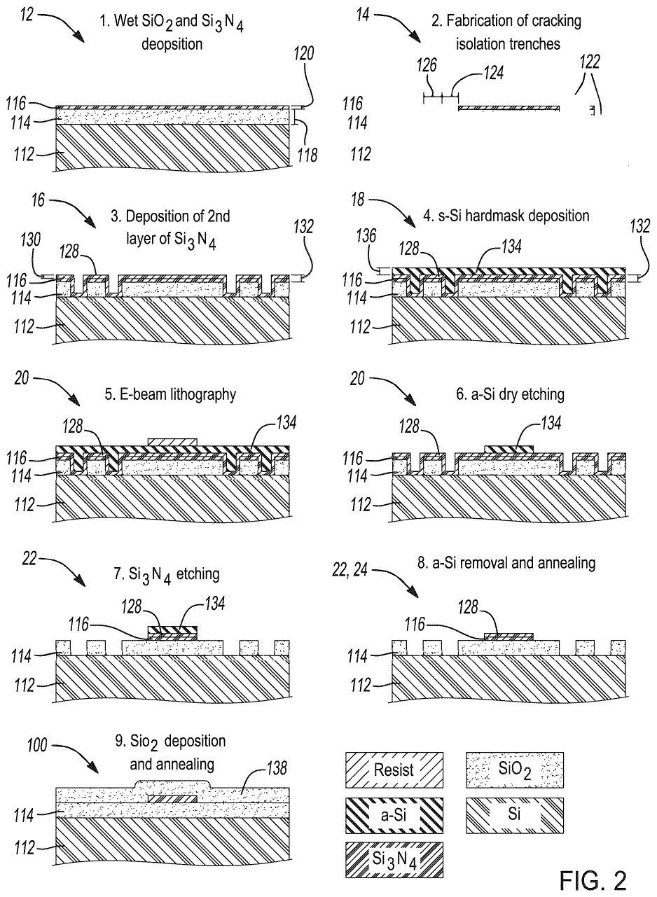

FIGS. 1-2 are a flow chart and a schematic of a method 10 of fabricating a photonic integrated circuit 100 (FIG. 2) including a thick silicon nitride (Si₃N₄) film. As will be discussed in greater detail below, a “thick” silicon nitride film has a thickness of greater than or equal to about 600 nm. Preferably, the “thick” silicon nitride film has a thickness of greater than or equal to about 775 nm, or a thickness of greater than or equal to about 800 nm.

At step 12, method 10 includes receiving a wafer including a substrate 112, a first layer of silicon dioxide (SiO₂) 114, and a first layer of silicon nitride 116. In one example embodiment, the substrate 112 is a silicon substrate extending between a first surface and a second surface. The first layer of silicon dioxide 114 is disposed on the first surface of the substrate 112. The first layer of silicon nitride 116 is disposed on the first layer of silicon dioxide 114.

An average thickness 118 of the first layer of silicon dioxide 114 is defined between a first surface and a second surface of the first layer of silicon dioxide 114. An average thickness 120 of the first layer of silicon nitride 116 is defined between a first surface and a second surface of the first layer of silicon nitride 116. The average thickness 120 of the first layer of silicon nitride 116 is greater than or equal to about 50 nm to less than or equal to about 400 nm. Preferably, the average thickness 120 of the first layer of silicon nitride 116 is about 350 nm to 400 nm (e.g., 380 nm).

In one example embodiment, the wafer including the substrate 112, the first layer of silicon dioxide 114, and the first layer of silicon nitride 116 is pre-fabricated or assembled. In another example embodiment, the method 10 includes depositing the first layer of silicon dioxide 114 on the substrate 112 and/or depositing the first layer of silicon nitride 116 on the first layer of silicon dioxide 114 via low-pressure chemical vapor deposition (LPCVD). It is contemplated that other known deposition techniques, such as chemical vapor deposition, physical vapor deposition, or coating processes, such as plasma-enhanced chemical vapor deposition (PECVD), inductively coupled plasma chemical vapor deposition (ICP-CVD), physical vapor deposition (PVD), and/or combinations thereof, can also be used.

At step 14, the method 10 further includes forming one or more trenches 122 through the first layer of silicon nitride 116 and the first layer of silicon dioxide 114. More specifically, the one or more trenches 122 are formed through all or a portion of the thicknesses 118, 120 of the first layer of silicon nitride 116 and/or the first layer of silicon dioxide 114. In one example embodiment, the one or more trenches 122 are formed entirely through the first layer of silicon nitride 116 and the first layer of silicon dioxide 114.

The one or more trenches 122 are formed by etching, such as via electron beam lithography (EBL), deep ultraviolet (DUV) photolithography, ultraviolet (UV) photolithography, reactive ion etching (RIE), wet etching, and/or combinations thereof. In one example embodiment, UV photolithography is used to form trenches 122 through the entire first layer of silicon nitride 116 and the first layer of silicon dioxide 114. In another example embodiment, the UV photolithography is followed by RIE.

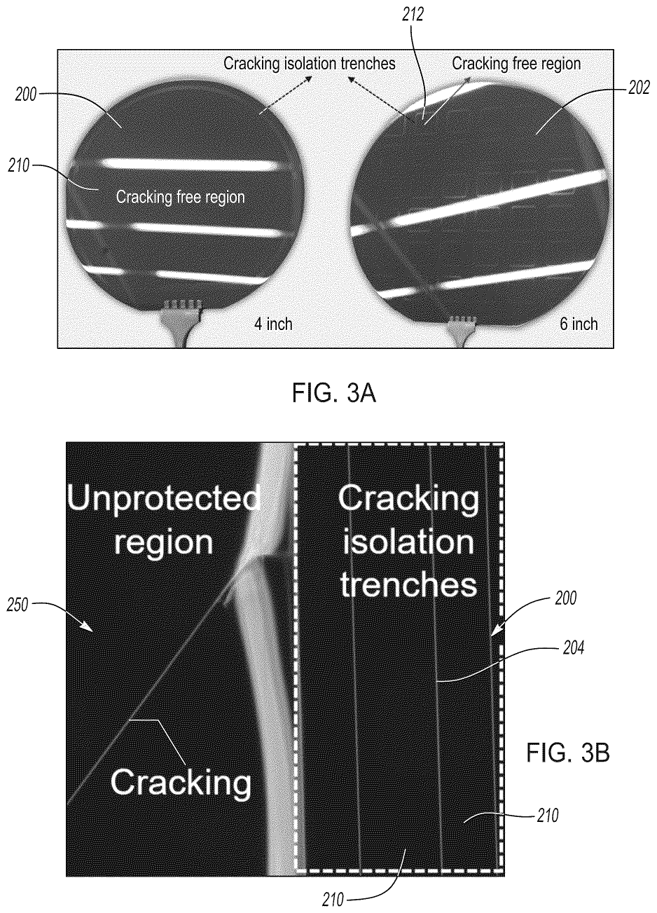

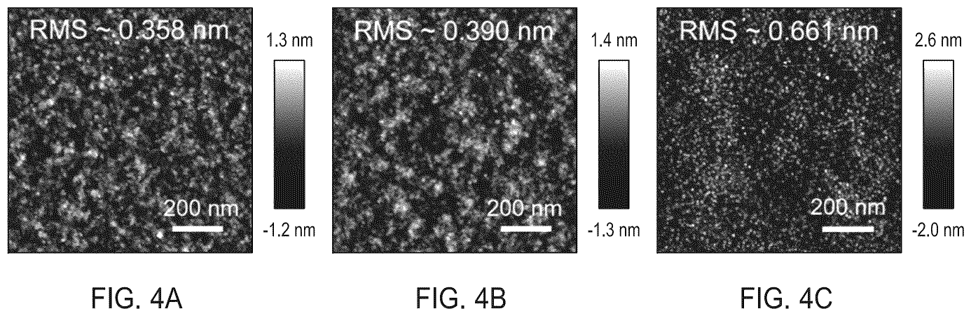

The one or more trenches 122 are configured to reduce or prevent crack formation in the first layer of silicon nitride 116. For example, the one or more trenches 122 are configured to terminate the propagation of cracks formed along the wafer edges, resulting in a protected crack-free region (see, e.g., crack free region 210 of FIGS. 3A-3B) during further growth of Si₃N₄. That is, the width, spacing, and depth of the one or more trenches 122 are tailored to relieve stress in the first layer of silicon nitride 114 and/or terminate crack propagation during fabrication of the photonic integrated circuit 100.

The one or more trenches 122 have a width 124 that is greater than or equal to about 3 micrometers (μm) to reduce and/or prevent crack formation. It is contemplated that the width 124 is greater than or equal to about 150 μm. In the example embodiment shown in FIG. 2, the width 124 is greater than or equal 50 μm to less than or equal to about 150 μm (e.g., 50 μm to 60 μm, 60 μm to 70 μm, 70 μm to 80 μm, 80 μm to 90 μm, 90 μm to 100 μm, 100 μm to 110 μm, 110 μm to 120 μm, 120 to 130 μm, 130 μm to 140 μm, and/or 140 μm to 150 μm). A dimension 126 between each of the one or more trenches 22 is greater than or equal to about 100 μm to less than or equal to about 220 μm (e.g., 100 μm to 120 μm, 120 μm to 140 μm, 140 μm to 160 μm, 160 μm to 180 μm, 180 μm to 200 μm, and/or 200 μm to 220 μm). In one example embodiment, the width 124 is about 80 μm and the dimension 126 is about 120 μm. In another example embodiment, the width 124 is about 100 μm and the dimension 126 is about 200 μm.

The one or more trenches 122 have a depth that is greater than or equal to about 2 μm. Trenches having a depth of greater than or equal to about 2 μm sufficiently relieve stress in the layers of the photonic integrated circuit.

The length of the one or more trenches 122 may be tailored according to the design of the photonic integrated circuit. In the example embodiment of FIG. 2, the one or more trenches 122 have a length that is greater than or equal to about 100 μm to less than or equal to about 100 millimeters (mm).

In some embodiments, the method further includes cleaning the wafer to ensure that all organic residues, particles, and other contaminants are removed. Cleaning reduces or eliminates defects on the surface of the first layer of silicon nitride 116 such that defects or cracking that could occur during subsequent silicon nitride deposited is reduced or eliminated. The cleaning is performed after forming the one or more trenches 122 and before depositing subsequent layers of silicon nitride.

Next, at step 16, the method 10 includes depositing a second layer of silicon nitride 128 on the first layer of silicon nitride 116. The depositing includes LPCVD, plasma-enhanced chemical vapor deposition (PECVD), inductively coupled plasma chemical vapor deposition (ICP-CVD), physical vapor deposition (PVD), and/or combinations thereof. In one example embodiment, the depositing is by LPCVD. An average thickness 130 of the second layer of silicon nitride 128 is defined between a first surface and a second surface of the second layer of silicon nitride 128. The average thickness 130 of the second layer of silicon nitride 128 is greater than or equal to about 200 nm. In one example embodiment, the average thickness 130 of the second layer of silicon nitride 128 is greater than or equal to about 400 nm.

A combined average thickness 132 of the first layer of silicon nitride 116 and the second layer of silicon nitride 128 is greater than or equal to about 600 nm, greater than or equal to about 775 nm, or preferably greater than or equal to about 800 nm. In one example embodiment, the combined average thickness 132 of the first layer of silicon nitride 116 and the second layer of silicon nitride 128 is about 850 nm.

Next, at step 18, the method 10 includes depositing another layer of silicon 134 on the second layer of silicon nitride 128. The another layer of silicon 134 has an amorphous structure (also referred to herein as “amorphous silicon layer 134,” “α-silicon layer 134,” or “α-Si layer 134”). In one example embodiment, the depositing includes LPCVD. An average thickness 136 of the α-Silicon layer 134 is defined between a first surface and a second surface of the α-Silicon layer 134. The average thickness 136 of the α-Silicon layer 34 is greater than or equal to about 400 nm.

The α-Silicon layer 134 is configured to be a hardmask for patterning the integrated circuit 100. The α-Silicon layer 134 in combination with the one or more trenches 122 reduces or eliminates crack formation and propagation in a thick silicon nitride film (i.e., the second layer of silicon nitride 128 disposed on the first layer of silicon nitride 116). While the one or more trenches 122 effectively reduce or prevent crack propagation during the depositing the second layer of silicon nitride 128, peeling-induced cracking of one or both of the silicon nitride layers 116, 128 may still occur (e.g., several weeks after fabrication). The introduced α-Silicon layer 134 serves as a protective layer that prevents peeling and cracking formation during dicing or manual cleaving, enabling long-term storage of the deposited silicon nitride wafers.

After depositing the α-Silicon layer 134, at step 20, the method 10 includes patterning at least one of the α-Silicon layer 134, the second layer of silicon nitride 128, the first layer of silicon nitride 116, and the first layer of silicon dioxide 114 to form the photonic integrated circuit 100. The patterning includes etching through at least one of the α-Silicon layer 134, the second layer of silicon nitride 128, the first layer of silicon nitride 116, and the first layer of silicon dioxide 114, such as via electron beam lithography (EBL), deep ultraviolet (DUV) photolithography, ultraviolet (UV) photolithography, reactive ion etching (RIE), nano imprint lithography (NIL), direct laser writing, inductively coupled plasma reactive ion etching (ICP-RIE), capacitively coupled plasma (CCP) etching, and/or combinations thereof. As shown in the schematic of FIG. 2, in one example embodiment, the patterning 20 is electron beam lithography (EBL) followed by reactive ion etching (RIE).

Next, at step 22, the method 10 includes removing the α-Silicon layer 134. In one example embodiment the removing is etching (e.g., XeF₂ etching (Xactix)). Next, at step 24, the method 10 includes annealing the photonic integrated circuit 100. Notably, the annealing the photonic integrated circuit 100 occurs after patterning at least one of the α-Silicon layer 134, the second layer of silicon nitride 128, the first layer of silicon nitride 116, and the first layer of silicon dioxide 114 and removing the α-Silicon layer 134. While it is possible to anneal the first layer of silicon nitride 116 prior to depositing the second layer of silicon nitride 128, it is not necessary. In these example embodiments, the first layer of silicon nitride 116 is not annealed prior to the deposition of the second layer of silicon nitride 128.

In some embodiments, at step 26 the method 10 further includes depositing a second layer of silicon dioxide 138 on the integrated circuit 100 (e.g., on the patterned second layer of silicon nitride 128, the first layer of silicon nitride 116, and/or the first layer of silicon dioxide 114). In one example embodiment, the depositing is by plasma-enhanced chemical vapor deposition (PECVD). In some embodiments, at step 28, the method 10 further includes another annealing of the photonic integrated circuit 100 after the step of depositing the second layer of silicon dioxide 138.

### Example 1

For proof of concept, a photonic integrated circuit in accordance with the present disclosure is fabricated and tested, using the method of FIGS. 1-2. Specifically, a mirroring resonator is fabricated using the method of FIGS. 1-2. A 4 μm thick wet thermal SiO₂ layer (the “first layer of SiO₂”) (see, e.g., the first layer of silicon dioxide 114 of FIG. 2) is deposited on a single-crystal silicon wafer (see, e.g., the substrate 112 of FIG. 2). A first layer of Si₃N₄ (see, e.g., the first layer of silicon nitride 116 of FIG. 2) having a thickness of about 380 nm is deposited on the first layer of SiO₂ using LPCVD. At this thickness, the tensile stress is manageable, minimizing the risk of Si₃N₄ film cracking.

Next, UV photolithography is used to pattern the cracking isolation trenches (e.g., the one or more trenches 122 of FIG. 2), after which inductively coupled plasma reactive ion etching (ICP-RIE) is utilized to etch both the first layer of Si₃N₄ and the full thickness of the underlying first layer of SiO₂.

After the etching, a cleaning protocol is used. The cleaning protocol includes oxygen plasma ashing, overnight Piranha cleaning, and two rounds of standard Radio Corporation of America (RCA) cleaning.

A second round of LPCVD deposition of a second layer of Si₃N₄ (see, e.g., the second layer of silicon nitride 128 of FIG. 2) increases the total film thickness (see, e.g., the combined average thickness 32) to about 800 nm, as required to enter the anomalous dispersion regime. Notably, there is not an annealing step between the two rounds of LPCVD Si₃N₄ deposition.

Immediately following the second round of Si₃N₄ growth, a α-Si layer (see, e.g., α-Silicon layer 134 of FIG. 2) is deposited via LPCVD to serve as a hardmask. In this study, both the 4-inch and 6-inch α-Si-protected Si₃N₄ on-SiO₂—Si wafers are stored in a cleanroom environment for over twelve (12) months, with no observed cracking in the protected regions.

Next, the Si₃N₄ on-SiO₂—Si wafers are patterned using EBL followed by Si₃N₄ RIE etching with the α-Si hardmask to create photonic integrated circuits (see, e.g., integrated circuit 100 of FIG. 2). After a full removal of the α-Si hardmask, the etched Si₃N₄ chips undergo high-temperature annealing, followed by the PECVD SiO₂ cladding deposition and an additional annealing process.

With reference to FIGS. 3A-3B, photographs of a 4-inch Si₃N₄ on-SiO₂—Si wafer 200 (left) and 6-inch Si₃N₄ on-SiO₂—Si wafer 202 (right) (the “wafers”) are fabricated by the method discussed above is shown. The 4-inch wafer 200 includes five (5) 100 μm-wide cracking isolation trenches 204 (FIG. 3B) spaced 200 μm apart introduced near the wafer edge. Cracking in a thick Si₃N₄ film typically originating at the wafer edges are effectively blocked by these trenches. In contrast to the existing thick Si₃N₄ deposition approaches that are only capable of creating small crack-free regions confined to the central area of the wafer, by forming trenches at the wafer edge the usable working area of the wafer is increased. For example, as shown in FIG. 3B, compared to a conventional wafer 250 (left), the Si₃N₄ on-SiO₂—Si wafer 200 (right) reduces or eliminates cracks. Thus, a protected crack-free region 210 is formed. Moreover, the trench design not only improves yield but also ensures consistent crack-free performance. In this research, all of the 19 4-inch developed wafers 200 remain intact within the protected crack-free regions 210.

The 6-inch wafer 202 includes a total of thirty-two (32) crack-free dies 212 (e.g., dies including crack free regions), each containing six (6) 80 μm-wide cracking isolation trenches spaced 120 μm apart. After the α-Si film deposition, the 6-inch wafers 202 are diced into crack-free 2 cm×2 cm dies prior to the subsequent EBL exposure.

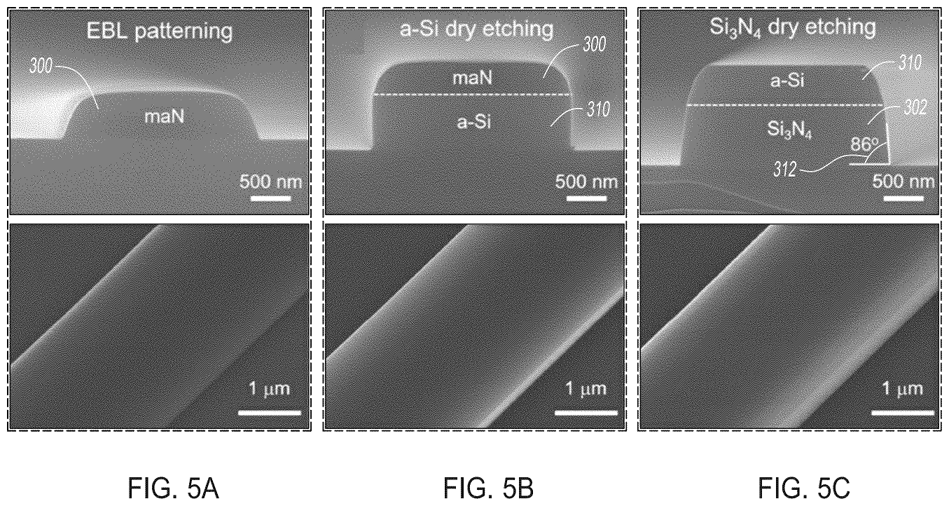

With reference to FIGS. 4A-4C, atomic force microscopy (AFM) measurements of a surface roughness of the wafer at each deposition stage is shown. FIG. 4A shows the surface roughness of the initial 380-nm Si₃N₄ film. The root mean square (RMS) surface roughness of deposited 380-nm LPCVD Si₃N₄ in the first round is measured to be 0.358 nm. FIG. 4B shows the surface roughness of the 800-nm Si₃N₄ film after the second deposition. The second round of deposition of LPCVD Si₃N₄ layer slightly increases the RMS roughness to 0.390 nm. Comparing both values with those reported in previous studies indicates high quality of the Si₃N₄ film. The exceptional surface smoothness is due to the α-Si hardmask, in lieu of poly-Si, deposited at a lower temperature to reduce e-beam or photon scattering during exposure, thereby minimizing additional resist edge roughness. FIG. 4C shows the surface roughness of the α-Si hardmask layer after deposition. The RMS surface roughness of the α-Si film is 0.661 nm, which is sufficiently smooth for the subsequent EBL exposure.

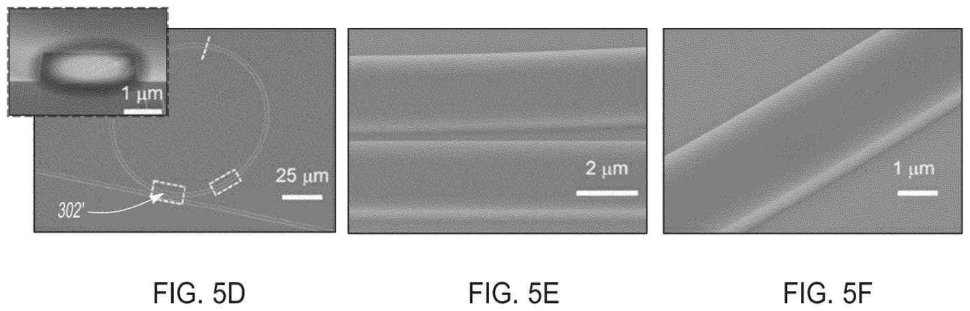

With reference to FIGS. 5A-5C, cross-sectional and tilted-view scanning electron microscope (SEM) images of the patterning steps are shown. Microring resonators are patterned using EBL exposure in a JEOL 6300 system. The maN 2405 resist 300 (FIGS. 5A and 5B) is employed for single-pass writing at a uniform exposure dose of 700 μC/cm2, with a beam current of 2 nA and a step size of 8 nm. After development, the maN 2405 resist 300 is thermally reflowed on a hotplate to reduce edge roughness, as shown in FIG. 5A. Subsequently, a two-step ICP-RIE etching process is developed to define the Si₃N₄ microring resonators 302 (FIG. 5C). The maN 2405 patterns 300 are first transferred to the α-Si hardmask layer 310 (FIG. 5B), which is slightly over-etched using optimized ICP-RIE (LAM 9400) recipes with HBr and He gases.

As best shown in FIG. 5B, this process achieves a high etching selectivity of about 5:1 (α-Si:maN 2405), resulting in a vertical α-Si hardmask 310 (FIG. 5B) with smooth sidewalls, despite the maN 2405 resist 300 having a slanted shape after reflow. It should be noted that the α-Si hardmask 310 is utilized due to its well-developed compatibility with industry silicon processing recipes and equipment, facilitating the smooth patterning and etching as compared to directly etching Si₃N₄.

As shown in FIG. 5C, after removing the residual maN 2405 resist 300, the Si₃N₄ layer 302 is etched using another ICP-RIE system (STS APS DGRIE), with a gas mixture of C₄F₈, CF₄, and helium (He). In the process, C₄F₈ is introduced primarily due to its protective properties during Si etching, which, in tandem with Si₃N₄, ensures a high etching selectivity. CF₄ is added to adjust the C:F ratio as a knob that balances passivation and etching to simultaneously maintain high etching selectivity, high etching rate, and smooth sidewalls of the Si₃N₄ waveguides. Helium dilutes and stabilizes the plasma, leading to stable etching performance under low processing pressure. The etching process is optimized at proper levels of high RF power and low pressure to bias toward a physical-etching-dominated regime, achieving stable Si₃N₄ etching at high rates (approximately 340 nm/min) while being less prone to contamination in a shared ICP-RIE chamber environment caused by other etching processes, such as aluminum metal hardmasks.

The physical-etching-dominated process slightly erodes the corners of the α-Si hardmask 310. Nonetheless, benefiting from the high etching selectivity (Si₃N₄:α-Si˜4:1), the process still yields vertical sidewalls with smooth surfaces at an angle 312 of 86 degrees for the Si₃N₄ waveguides 302. Consistent etching parameters are maintained with rarely observed variations in etching rates, etching selectivity, sidewall angles, and sidewall roughness, indicating high reliability and stability of our optimized etching process.

The fabrication process then proceeds with using XeF₂ etching (Xactix) to isotropically remove the residual α-Si, followed by standard RCA cleaning to eliminate the remaining particles. The wafers are annealed at 1100° C. in an N₂ environment for 6 hours.

With reference to FIGS. 5D-5F the fabricated Si₃N₄ microring resonator 302′ after α-Si removal and annealing is shown. The false-colored SEM images in FIGS. 5E and 5F highlight the smooth edges and sidewalls at the waveguide-microring coupling region and along the microring waveguide, suggesting a low scattering loss and high-Q factor.

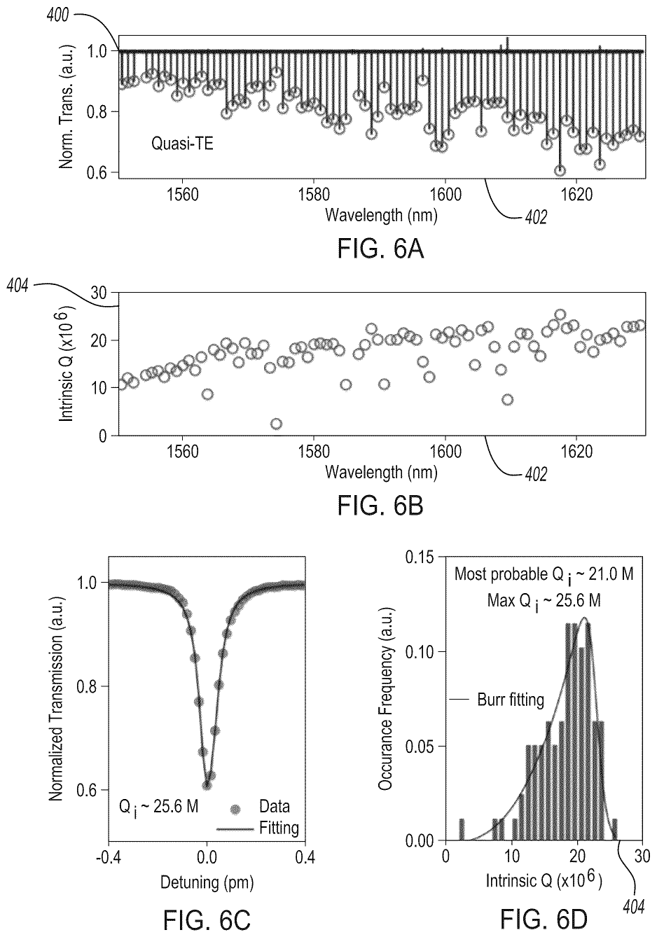

Referring to FIGS. 6A-6H, the fabricated Si₃N₄ microring resonators are characterized. To characterize the optical loss of the fabricated Si₃N₄ PICs, we measure Q factors of the microring resonators designed to operate in the anomalous dispersion regime. The microring resonator consists of a 2.8 μm-wide, 0.8 μm-high ring waveguide with a radius (R) of 200 μm. A straight bus waveguide with a width of 2.0 μm is coupled to the microring resonator with a coupling gap of 525 nm, enabling efficient excitation of the fundamental TE₀₀ or TM₀₀ mode. To achieve high fiber-to-chip coupling efficiency, lens fibers are employed in combination with tapered waveguide mode converters featuring a tip dimension of 0.2 μm×0.8 μm, resulting in a coupling efficiency exceeding 70%. The transmission spectra are obtained using a tunable laser (TSL-570) at low optical power to minimize thermo-optic effects and a low-noise photodetector (Newport 1811) to measure the transmitted light. The data are read out and recorded using a data acquisition card (DAQ).

FIGS. 6A and 6E show the measured normalized transmission spectra 400 for the quasi-TE and quasi-TM modes over the wavelength range 402 of 1550 nm to 1630 nm, respectively. A spectra a fitting model is applied to calculate the Q factors using the formula Q_{i,ex}=λ₀/κ_{0,ex}, where λ₀ is the resonant wavelength and κ_{0,ex} represents the intrinsic and coupling linewidths. We assume in the analysis that all resonant modes operate in the undercoupled regime (κₑₓ<κ₀). The extracted Q factors 404 for the quasi-TE₀₀ and quasi-TM₀₀ fundamental modes presented in FIGS. 6B and 6F show that most resonances exhibit high Qᵢ exceeding 10×10⁶.

FIG. 6C shows a zoom-in view on the quasi-TE resonance at λ₀=1617.381 nm that exhibits the highest Qᵢ=25.6×10⁶, extracted from a fitted intrinsic linewidth of κ₀=6.32×10⁻² pm. The waveguide propagation loss a is then inferred as follows:

$$α = \frac{2 π {n}_{δ}}{Q i λ 0} \qquad ( 1 )$$

where n_{δ} is the group index, and determined to be α˜1.6 dB/m. Similarly, the highest intrinsic quality factor for the quasi-TM resonances is inferred as Qᵢ=22.8×10⁶, corresponding to a propagation loss of a ˜2.0 dB/m.

FIGS. 6D and 6H show histograms of the extracted Qᵢ factors 404. The distributions are modeled using Burr curves, and the maximum value of each fitted curve is defined as the most probable Qᵢ factor, which amounts to 21.0×10⁶ for the quasi-TE₀₀ modes and 17.8×10⁶ for the quasi-TM₀₀ modes. These results underscore the consistent high-Q performance endowed by the low propagation loss waveguides of the fabricated Si₃N₄ microring resonators.

Notably, a sharp drop in Qᵢ from over 20×10⁶ to approximately 10×10⁶ in the wavelength range from 1580 nm to 1550 nm is observed for both the quasi-TE00 (FIG. 6B) and quasi-TM00 (FIG. 6F) modes. Beyond 1580 nm, the Qᵢ values stabilize and drift around 20×10⁶. This trend suggests that the lower Q values near 1550 nm are not primarily attributed to fabrication-induced roughness, such as waveguide scattering loss, but are instead significantly influenced by material absorption-specifically, hydrogen bond (H-bond) absorption in the Si₃N₄ waveguide and PECVD SiO₂ cladding.

Another prominent degradation in the Qᵢ factor is observed between 1550 nm and 1520 nm, with a minimum at around 1520 nm, where the H-bound absorption peak situates. Conversely, the Q factor exhibits a gradual increase from 1520 nm to 1490 nm, raising Qᵢ=5.2×10⁶ at 1520 nm to Qᵢ=13.0×10⁶ at 1490 nm. However, since scattering loss is inversely proportional to A, shorter wavelengths are anticipated to experience higher scattering loss compared to longer wavelengths. As such, the much higher Q at shorter wavelength (1490 nm vs 1520 nm) further corroborates that the relatively low observed Qᵢ values are not predominantly caused by nanofabrication-induced scattering loss. Rather, they are due to the residual H-bonds that result in additional material absorption.

Despite the considerable potential in further reducing the optical loss by higher annealing temperature and LPCVD SiO₂ cladding, the demonstrated performance of the thick Si₃N₄ platform is already on par with state-of-the-art. Notably, the α-Si hardmask etching method offers benefits beyond ultra-low loss as discussed at the outset, including the ability for long-term storage in a ready-to-use state, ultra-high etching selectivity, high yield, robustness to RIE equipment variations, user-friendliness, and, most importantly, the ability to fully leverage well-developed equipment, processes, and infrastructure from the silicon industry.

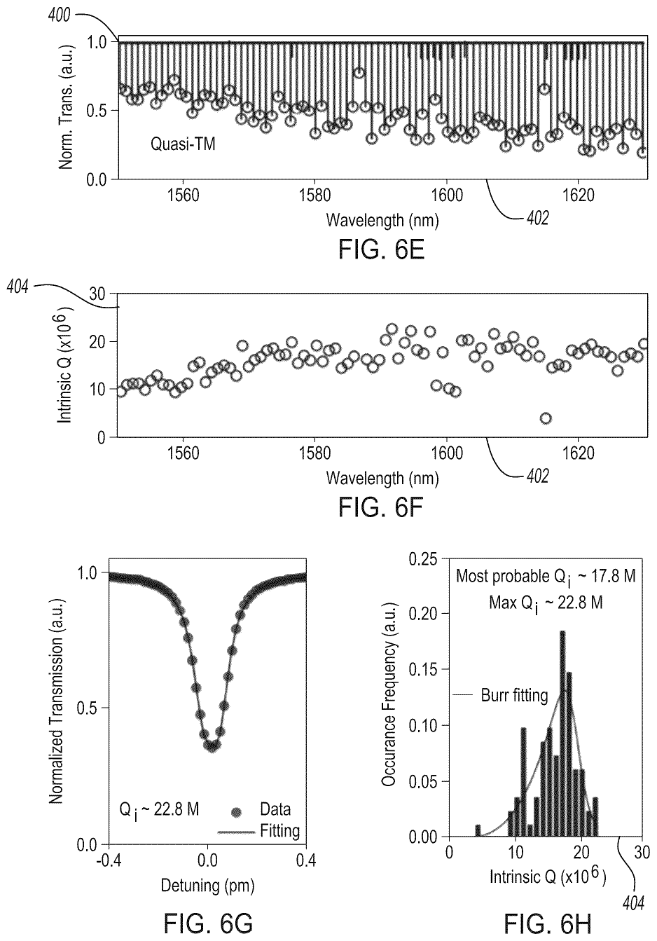

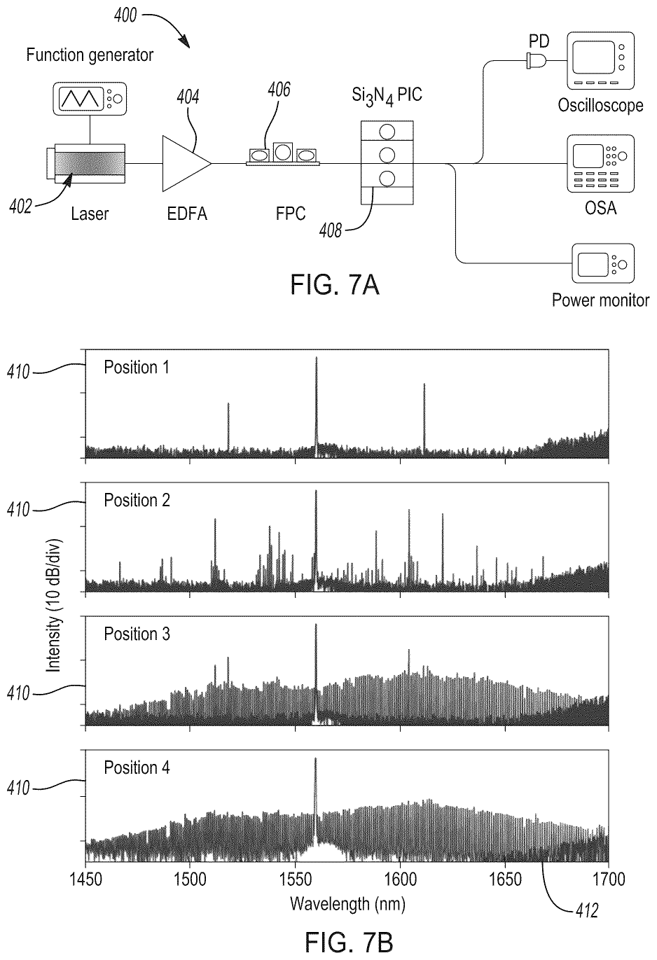

With reference to FIGS. 7A-B, frequency combs are generated to show the thick Si₃N₄ photonic integrated circuit's use in nonlinear and quantum optics applications. Operating at an anomalous dispersion wavelength is crucial to generate frequency combs while low optical loss reduces the threshold and thereby the required pump power. The 800-nm thickness of the Si₃N₄ layer provides greater flexibility in attaining anomalous dispersion with a wider waveguide, while thinner Si₃N₄ films in general require narrower waveguides to achieve anomalous dispersion, which comes with increased optical loss due to a higher overlap between the waveguide modes and rough sidewalls.

In frequency comb generation, the same Si₃N₄ microring resonator geometry of a radius R=200 μm and waveguide dimension of 2.8 μm×0.8 μm is employed in the experimental setup 400 shown in FIG. 7A. The output from a tunable pump laser 402 is boosted by an erbium-doped fiber amplifier (EDFA) 404 to about 50 mW. A fiber polarization controller (FPC) 404 is used to fine-tune the polarization prior to injecting the light to excite the quasi-TE waveguide modes of the Si₃N₄ chip 408. Using a function generator, we control the pump wavelength of the tunable laser 402 to approach a target high-Q resonance near 1560 nm.

The generated frequency combs displayed on an optical spectrum analyzer (OSA) is presented in FIG. 7B, illustrating the evolution of the generated frequency comb as the pump wavelength is tuned into the resonance. Positions 1 to 4 (FIG. 7B) show the frequency combs 410 generated at different laser wavelengths 412 in approaching the microring resonance. At position 1, initial four-wave mixing (FWM) sidebands are generated near the pump as its wavelength begins to approach resonance, marking the onset of comb formation. At position 2, increased cascaded FWMs and the generation of additional comb lines take place as more optical power is coupled into the resonator due to the pump wavelength getting closer to the resonance. At position 3, further cascaded FWM processes generate more comb teeth and create a denser frequency comb spectrum as the pump wavelength approaches even closer to the resonance. At Position 4, a broad chaotic modulation-instability (MI) frequency comb is generated, with each tooth spaced by one free spectral range (FSR), when the pump wavelength is very close to the resonance. The above results highlight the effectiveness of the fabricated Si₃N₄ microring resonators in generating dense and broadband frequency combs, demonstrating their potential in applications pertaining to optical communication, precision metrology, spectroscopy, among others.

### Example 2

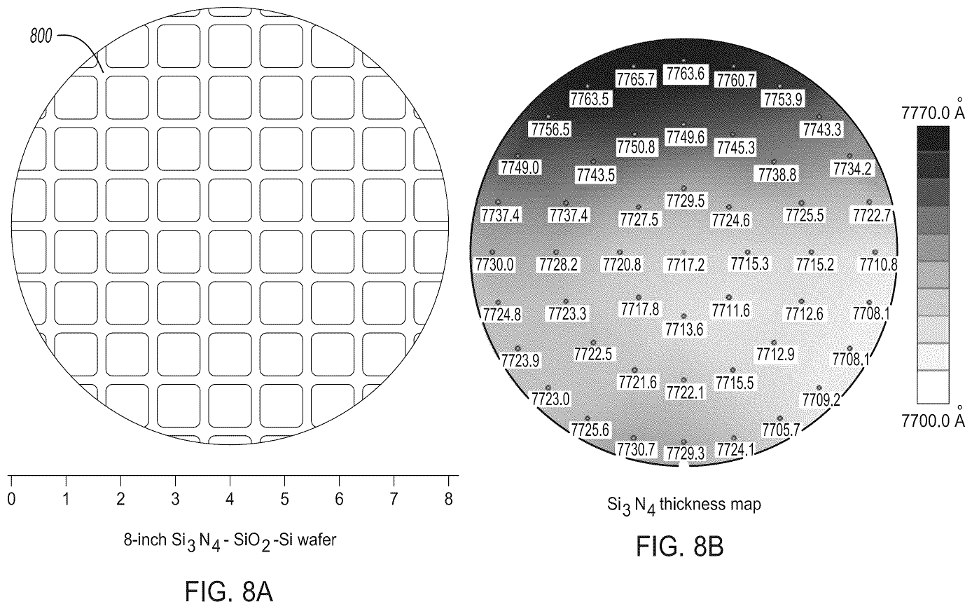

For proof of concept, a photonic integrated circuit in accordance with the present disclosure is fabricated and tested, using the method of FIGS. 1-2. Specifically, a microring resonator is fabricated using the method of FIGS. 1-2. With reference to FIGS. 8A-8B, a photonic integrated circuit 500 is fabricated. A 4 μm thick wet thermal SiO₂ layer (the “first layer of SiO₂”) (see, e.g., the first layer of silicon dioxide 114 of FIG. 2) is deposited on a single-crystal silicon wafer (see, e.g., the substrate 112 of FIG. 2). A first layer of Si₃N₄ (see, e.g., the first layer of silicon nitride 116 of FIG. 2) having a thickness of about 380 nm is deposited on the first layer of SiO₂ using LPCVD.

Next, deep-ultraviolet (DUV) photolithography is used to pattern the cracking isolation trenches (see, e.g., the one or more trenches 122 of FIG. 2), after which inductively coupled plasma reactive ion etching (ICP-RIE) is utilized to etch both the first layer of Si₃N₄ and the full thickness of the underlying first layer of SiO₂. One or more trenches are formed by the patterning. The one or more trenches are configured to reduce or eliminate cracking in the photonic integrated circuit.

After the etching, a resist (e.g., a resist used in the DUV photolithography step) is removed and a cleaning protocol is used.

A second round of LPCVD deposition of a second layer of Si₃N₄ (see, e.g., the second layer of silicon nitride 128 of FIG. 2) increases a total film thickness (see, e.g., the combined average thickness 132) to about 775 nm. In the example embodiment shown in FIGS. 8A-8B, the total film thickness of Si₃N₄ is 777.9 nm with a uniformity of plus or minus 0.4% (FIG. 8B). A uniformity of plus or minus 0.4% total film thickness enables precise dispersion control across the entire wafer.

FIG. 8A shows a photograph of the 8-ich inch Si₃N₄ on-SiO₂—Si wafer 500. Inspection of each die on the fabricated wafer 500 reveal no cracking within one or more crack-free regions.

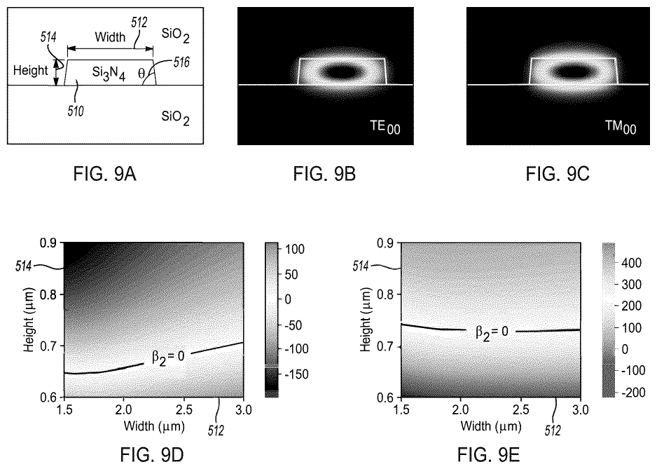

With reference to FIG. 9A-9E, a numerically simulated group velocity dispersion #₂ of a straight Si₃N₄ waveguide for the fundamental TE₀₀ and TM₀₀ modes is calculated using the commercial software COMSOL analysis. FIG. 9A is a cross-section schematic of a Si₃N₄ waveguide 510. The Si₃N₄ waveguide 510 defines a width 512 and a height 514. In the example embodiment, a sidewall angle 516 is about 85 degrees in the simulation to match the geometry of the fabricated photonic integrated circuit 500 (FIG. 8A). FIGS. 9B and 9C are the electrical field distributions of the TE₀₀ (FIG. 9B) and TM₀₀ (FIG. 9C) modes, respectively. FIGS. 9D and 9E are simulated group velocity dispersion #₂ maps as functions of waveguide width 512 and height 514 for the TE₀₀ (FIG. 9D) and TM₀₀ (FIG. 9E) modes, respectively, at a wavelength of 1570 nm. FIGS. 9D-9E demonstrate robust anomalous dispersion (β₂<0) for Si₃N₄ film thickness (see, e.g., thickness 502 of FIGS. 8A-8B) exceeding 750 nm. These multimode waveguide dimensions provide flexible dispersion control. Additionally, these multimode waveguide dimensions reduce the interaction with sidewall roughness, contributing to lower propagation loss.

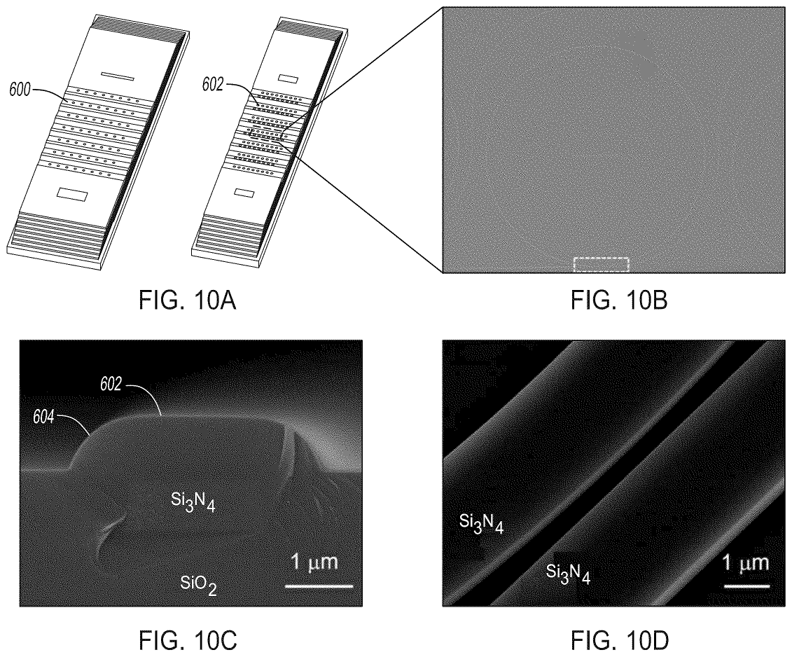

Referring to FIG. 10A-10D, SEM photographs of Si₃N₄ photonic integrated circuits fabricated using the methods described in FIGS. 1-2 are shown. These methods combine a high etch rate, excellent etching selectivity, smooth and vertical waveguide sidewalls, and robustness to variations in the RIE chamber environment.

The Si₃N₄ photonic integrated circuit 600 is fabricated using EBL to form one or more trenches. For EBL exposure, the samples are patterned using a JEOL 6300 system with maN 2405 resist, supporting fabrication of small features.

The Si₃N₄ photonic integrated circuit 602 is fabricated using UV stepper lithography to form one or more trenches. For UV stepper exposure, the GCA AS200 system with SPR 955 photoresist is employed, which algins well with the foundry-grade DUV stepper photolithography for mass production.

For both samples, after initial patterning, the resist patterns of are subsequently transferred into the α-Si hardmask (see, e.g., the another layer of silicon 134 of FIG. 2) via the ICP-RIE etching using the LAM 9400 system with HBr and He gases. The Si₃N₄ layer is then etched using another ICP-RIE system (STS APS DGRIE) with a gas mixture of C₄F₈, CF₄, and He. The residual α-Si hardmask is removed using XeF₂ etching (Xactix), followed by RCA cleaning and high-temperature annealing at 1100 degrees Celsius to drive out the hydrogen. Finally, a SiO₂ cladding layer is deposited and annealed before testing.

FIG. 10B shows a SEM image of the fabricated Si₃N₄ microring resonator 602. The vertical sidewalls 604 of the bus waveguide are clearly visible in the cross-section SEM image shown in FIG. 10C. FIG. 10D shows a zoomed-in view of a bus-to-resonator gap region. No obvious sidewall and surface roughness is observed, indicating the fabrication process is high quality.

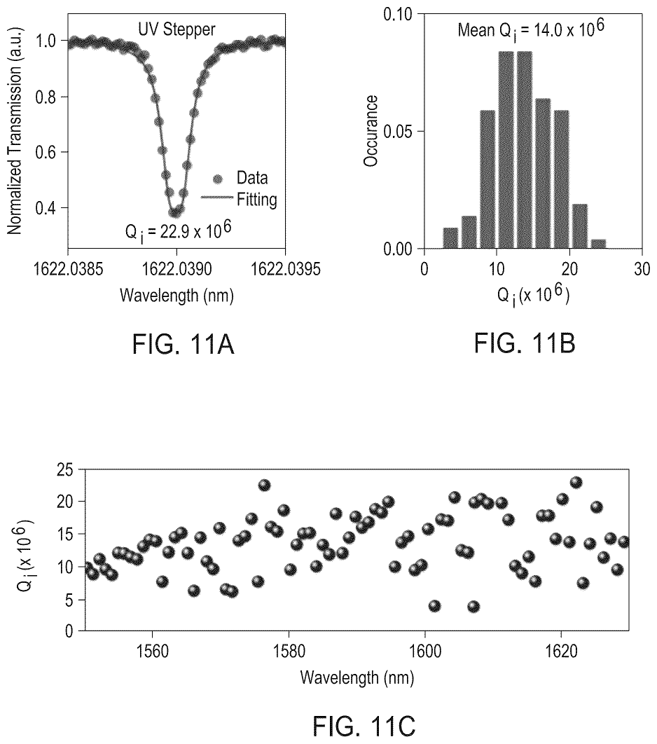

With reference to FIGS. 11A-11F, the performance of the fabricated Si₃N₄ photonic integrated circuits is characterized. The transmission spectra of the microring resonators is measured. A continuous-wave (c.w.) tunable laser (Santec TSL770) is used to sweep the laser wavelength across the resonances. To minimize the thermal effects, the input laser power is limited to approximately 30 μW. The transmitted light is collected from the bus waveguide using a low-noise photodetector and monitored with an oscilloscope. FIG. 11A shows the typical transmission spectra of high-Q fundamental TE₀₀ mode of a macroing resonator fabricated using UV stepper, with a radius of 200 μm and a waveguide width of 2.7 μm, corresponding to a free spectral range of 114 GHz. The bus waveguide width is set to 2.0 μm to ensure good phase matching with the fundamental TE₀₀ modes of the microring resonator. For each resonance, both the intrinsic linewidth and coupling linewidth are extracted, while maintaining a coefficient of determination R² value greater than 0.99. It is assumed that all resonances operate in the undercoupled regime. As shown in FIG. 11A, the maximum extracted intrinsic Q factor (Qᵢ) is Qᵢ=22.9×10⁶, corresponding to a propagation loss of 1.54 dB/m. FIG. 11B shows the statistical distribution of the Qᵢ values. The majority of resonances exhibit Qᵢ values exceeding 10.0×10⁶, with a mean Qᵢ=14.1×10⁶ and a corresponding mean propagation loss of 2.54 dB/m. This indicates the robustness and reproducibility of the fabrication process described herein. The wavelength dependence of Qᵢ is shown in FIG. 11C. In general, resonances at longer wavelengths exhibit higher Qᵢ, attributed to reduced scattering losses and lower material absorption. A few resonances with relative lower Qᵢ values (<5.0×10⁶) are attributed to mode coupling with higher-order, low-Q modes, which could be further suppressed by improving the coupling ideality. Additional measurement results for the TM₀₀ mode of the same microring resonator demonstrate a maximum Qᵢ=24.5×10⁶ and a mean Qᵢ=12.1×10⁶.

FIGS. 11D-11F show the corresponding measurement results for the EBL-fabricated microring resonators with identical geometry and the same TE00 mode, achieving a maximum Qᵢ=22.9×10⁶. Compared with UV stepper photolithography, EBL provides advantages in fabricating small features and achieving improved waveguide geometry control. As shown in FIG. 11E, the EBL-fabricated Si₃N₄ microring exhibits a denser distribution of Qᵢ values benefiting from reduced mode couplings, resulting in a higher mean Qᵢ=16.9×10⁶. Additional improvements are anticipated using a foundry-grade DUV stepper system along with the described α-Si hardmask etching technique. (see, FIGS. 1-2). This method has the potential to offer the combined benefits of ultra-low loss, mass production, and the ability to define small feature sizes (e.g., tapered waveguides and grating couplers).

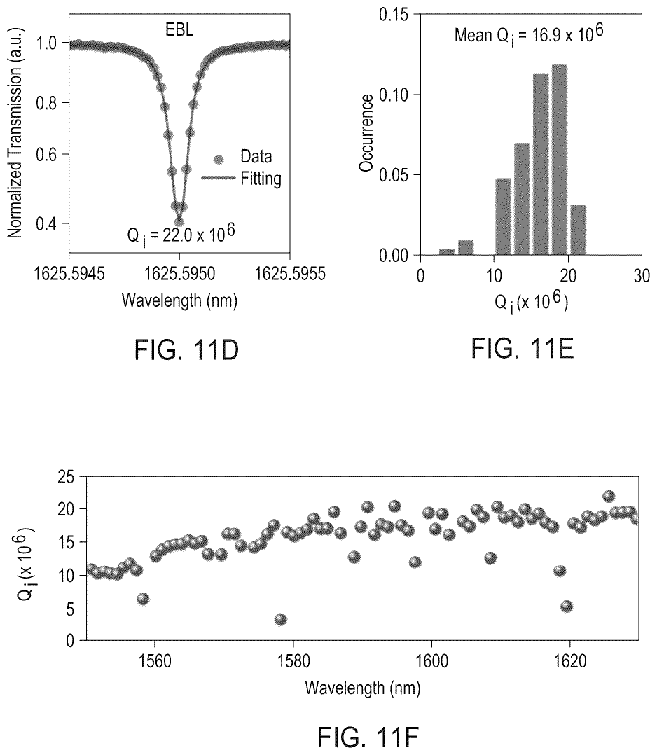

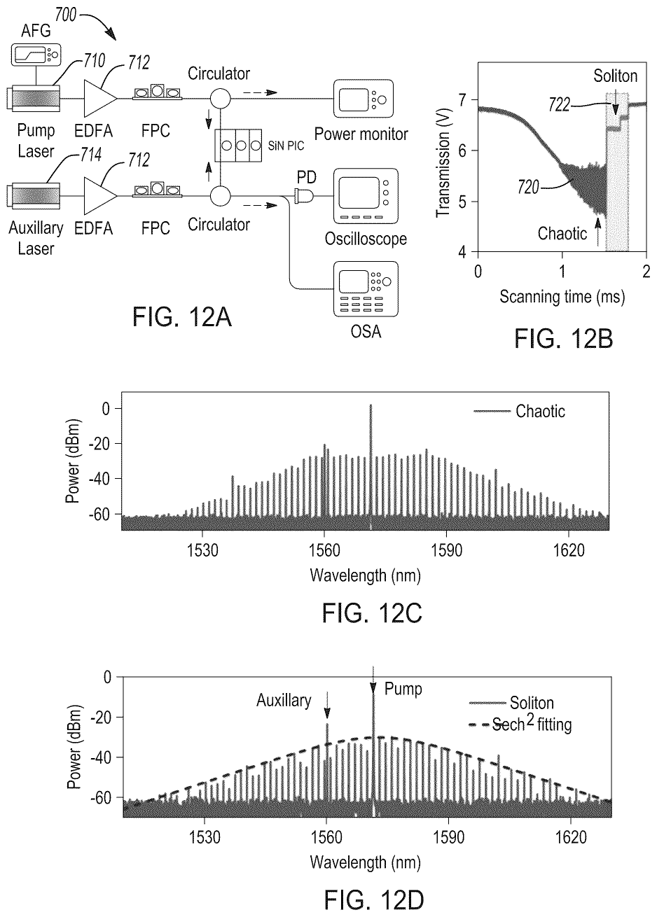

With reference to FIGS. 12A-12D, the generation of broad Kerr frequency combs, driven by third-order nonlinearity and tailored anomalous dispersion, has made thick Si₃N₄ photonic integrated circuit platforms highly effective for various important applications in nonlinear optics and quantum optics. Several techniques can be utilized to access soliton states, including power kicking, rapid laser scanning, and/or auxiliary-laser-assisted thermal compensation. In one example embodiment, as shown in FIG. 12A, to demonstrate soliton frequency comb generation on the fabricated Si₃N₄ photonic integrated circuits, an auxiliary-laser-assisted bi-pumping experimental setup 700 is utilized. To enable reliable access to the soliton states, a photonic integrated circuit 702 has a layer of Si₃N₄ microring 704 with a radius of 100 μm and a waveguide width of 2.0 μm, designed to minimize mode coupling (which is known to inhibit soliton formation). A c.w. pump laser 710 is amplified by an erbium-doped fiber amplifier (DFA) 712 and coupled into a TE₀₀ resonance near 1571 nm (Q=5.5×10⁶). Simultaneously, an auxiliary laser 714 is coupled into a TM00 mode (Q=3.0×10⁶) around 1560.1 nm, with its wavelength fixed on the blue-detuned side of the resonance. The auxiliary laser 714 helps compensate for the sudden intracavity power drop that occurs as the primary pump 710 transitions from the chaotic regime into the soliton regime. This improved thermal stabilization significantly extends the accessible soliton window, as shown in FIG. 12B, where chaotic region 720 and clear soliton steps 722 are observed. To record the corresponding frequency comb spectra, an arbitrary function generator is used to sweep the pump laser wavelength and hold it at a target state. FIG. 12C shows the frequency comb spectrum obtained in the chaotic regime 720. To generate the soliton frequency comb, the pump laser 710 is swept across the chaotic regime 720 and stabilized on the solution step 722 at an on-chip pump power of 18 mW. The resulting soliton frequency comb spectrum is shown in FIG. 12D, with a fitted sech² envelope overlaid. Overall, the experimental results highlight the potential of foundry-level fabrication of high-performance Si₃N₄ photonic integrated circuits for advanced applications in nonlinear optics and quantum information processing.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of fabricating a photonic integrated circuit, comprising:
forming one or more trenches through a first layer of silicon nitride and a first layer of silicon dioxide on a substrate, wherein the first layer of silicon dioxide is disposed on the substrate and the first layer of silicon nitride is disposed on the first layer of silicon dioxide;
depositing a second layer of silicon nitride on the first layer of silicon nitride;
depositing another layer of silicon on the second layer of silicon nitride, wherein the another layer of silicon has an amorphous structure;
patterning at least one of the another layer of silicon, the first and second layers of silicon nitride, and the first layer of silicon dioxide, thereby forming the integrated circuit; and
removing the another layer of silicon.

2. The method of claim 1, further comprising annealing the integrated circuit, wherein the annealing is performed after removing the another layer of silicon.

3. The method of claim 1, further comprising depositing a second layer of silicon dioxide on the integrated circuit.

4. The method of claim 3, wherein the depositing the second layer of silicon dioxide includes plasma-enhanced chemical vapor deposition (PECVD), low-pressure chemical vapor deposition (LPCVD), inductively coupled plasma chemical vapor deposition (ICP-CVD), physical vapor deposition (PVD), or combinations thereof.

5. The method of claim 2, the method further comprising another annealing the integrated circuit performed after the step of depositing the second layer of silicon dioxide.

6. The method of claim 1, wherein the forming one or more trenches includes etching entirely through a thickness of the first layer of silicon nitride and a thickness of the first layer of silicon dioxide.

7. The method of claim 1, the method further comprising cleaning a surface of the first layer of silicon nitride performed before the step of depositing the second layer of silicon nitride.

8. The method of claim 1, wherein the depositing includes low-pressure chemical vapor deposition (LPCVD), plasma-enhanced chemical vapor deposition (PECVD), inductively coupled plasma chemical vapor deposition (ICP-CVD), physical vapor deposition (PVD), or combinations thereof.

9. The method of claim 1, wherein the patterning includes electron beam lithography (EBL), deep ultraviolet (DUV) photolithography, ultraviolet (UV) photolithography, nano imprint lithography (NIL), direct laser writing, reactive ion etching (RIE), inductively coupled plasma reactive ion etching (ICP-RIE), capacitively coupled plasma (CCP) etching, or combinations thereof.

10. The method of claim 1, wherein the removing the another layer of silicon comprises etching.

11. The method of claim 1, the method further comprising depositing the first layer of silicon dioxide on the substrate performed prior to the forming the one or more trenches.

12. The method of claim 1, the method further comprising depositing the first layer of silicon nitride on the first layer of silicon dioxide performed prior to the forming the one or more trenches.

13. The method of claim 1, wherein an average thickness of the first layer of silicon nitride and the second layer of silicon nitride combined is greater than or equal to about 800 nanometers.

14. A method of fabricating a photonic integrated circuit, comprising:
forming one or more trenches through a first layer of silicon nitride and a layer of silicon dioxide on a substrate, wherein the layer of silicon dioxide is disposed on the substrate and the first layer of silicon nitride is disposed on the layer of silicon dioxide,
depositing a second layer of silicon nitride on the first layer of silicon nitride;
depositing another layer of silicon on the second layer of silicon nitride, wherein the another layer of silicon has an amorphous structure;
patterning at least one of the another layer of silicon, the first and second layers of silicon nitride, and the layer of silicon dioxide, thereby forming the integrated circuit; and
removing the another layer of silicon,
wherein:
a first average thickness of the first layer of silicon nitride is greater than or equal to about 50 nanometers to less than or equal to about 400 nanometers,
a second average thickness of the second layer of silicon nitride is greater than or equal to about 200 nanometers, and
a combined average thickness of the first layer of silicon nitride and the second layer of silicon nitride is greater than or equal to about 600 nanometers.

15. The method of claim 14, wherein the combined average thickness is greater than or equal to about 775 nanometers.

16. The method of claim 14, wherein a third average thickness of the another layer of silicon is greater than or equal to about 400 nanometers.

17. The method of claim 14 wherein a width of the one or more trenches is greater than or equal to about 70 micrometers to less than or equal to about 110 micrometers.

18. The method of claim 14, wherein:
a width of the one or more trenches is greater than or equal to about 70 micrometers to less than or equal to about 90 micrometers, and
a dimension between the each of the one or more trenches is greater than or equal to about 110 micrometers to less than or equal to about 130 micrometers.

19. The method of claim 14, wherein:
a width of the one or more trenches is greater than or equal to about 90 micrometers to less than or equal to about 110 micrometers, and
a dimension between the each of the one or more trenches is greater than or equal to about 190 micrometers to less than or equal to about 210 micrometers.

20. The method of claim 14, further comprising annealing the integrated circuit, wherein the annealing is performed after removing the another layer of silicon.
